(19) United States
(12) Patent Application Publication
(10) Pub. No.: US 2026/0186346 A1
(43) Pub. Date: Jul. 2, 2026

(54) LIQUID CRYSTAL ALIGNMENT AGENT, DISPLAY PANEL AND METHOD FOR MANUFACTURING THE SAME

(71) Applicant: TCL CHINA STAR OPTOELECTRONICS TECHNOLOGY CO., LTD., Shenzhen (CN)

(72) Inventors: Shuang LU, Shenzhen (CN); Binbin HE, Shenzhen (CN); Baolin CHI, Shenzhen (CN); Hongyuan XU, Shenzhen (CN)

(73) Assignee: TCL CHINA STAR OPTOELECTRONICS TECHNOLOGY CO., LTD., Shenzhen (CN)

(21) Appl. No.: 19/242,980

(22) Filed: Jun. 19, 2025

(30) Foreign Application Priority Data
Dec. 31, 2024 (CN) 202411996883.6

(51) Int. Cl. G02F 1/1337; C08G 73/10; C09D 179/08

(52) U.S. Cl. CPC G02F 1/133723; C08G 73/1032; C08G 73/1078; C09D 179/08

(57) ABSTRACT

A liquid crystal alignment agent, a display panel and a method for manufacturing the same are provided. The display panel includes a first substrate, a second substrate disposed opposite to the first substrate, a liquid crystal layer disposed between the first substrate and the second substrate, and a liquid crystal alignment film disposed on a side of the first substrate close to the liquid crystal layer and/or a side of the second substrate close to the liquid crystal layer; and a material of the liquid crystal alignment film includes polyimide represented by formula I, in which R₁ represents a group obtained after decarboxylation of a tetracarboxylic dianhydride, and at least one of R₂ and R₃ is represented by formula II:

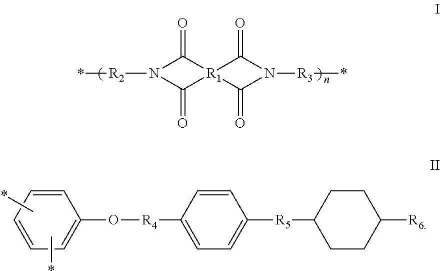

### CROSS-REFERENCE TO RELATED APPLICATION

This application claims the priority to and benefit of Chinese Patent Application No. 202411996883.6, filed on Dec. 31, 2024, the present disclosure of which is incorporated herein by reference in its entirety.

### TECHNICAL FIELD

The present disclosure relates to the field of display, and in particular, to a liquid crystal alignment agent, a display panel and a method for manufacturing the same.

### BACKGROUND

The liquid crystal display (LCD) has been widely used as the display component of electronic products such as a laptop, a smartphone, a television, and the like. The liquid crystal alignment layer is one of the important components of the LCD, and it has the function of controlling the deflection of liquid crystal molecules in the LCD.

The existing liquid crystal alignment films made from liquid crystal alignment agents may have problems with afterimages or bright spots, resulting in display non-uniformity (Mura) after the alignment of the liquid crystals.

### SUMMARY

Some embodiments of the present disclosure provide a display panel, including:
a first substrate;
a second substrate disposed opposite to the first substrate;
a liquid crystal layer disposed between the first substrate and the second substrate; and
a liquid crystal alignment film disposed on a side of the first substrate close to the liquid crystal layer and/or a side of the second substrate close to the liquid crystal layer, where a material of the liquid crystal alignment film includes polyimide represented by the following formula I:

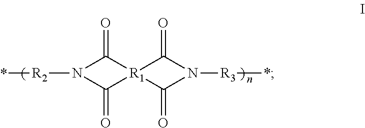

where R₁ represents a group obtained after decarboxylation of a tetracarboxylic dianhydride;
at least one of R₂ and R₃ is represented by the following formula II:

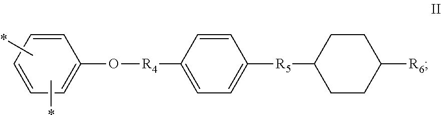

R₄, R₅, and R₆ are independently selected from a single bond, an alkyl group, an alkoxy group, a fluoroalkyl group, or a fluoroalkoxy group, at least two of R₄, R₅, and R₆ are not simultaneously selected from a single bond, and a sum of the number of carbon atoms in R₄, the number of carbon atoms in R₅, and the number of carbon atoms in R₆ is any integer from 2 to 11 at each occurrence;
n represents a positive integer; and
* represents a linking site.

Some embodiments of the present disclosure provide a liquid crystal alignment agent including at least one of polyimide represented by the following formula I or polyamic acid represented by the following formula III:

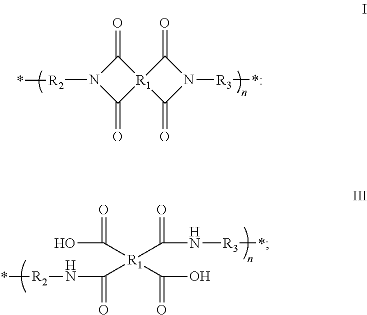

where R₁ represents a group obtained after decarboxylation of a tetracarboxylic dianhydride;
at least one of R₂ and R₃ is represented by the following formula II:

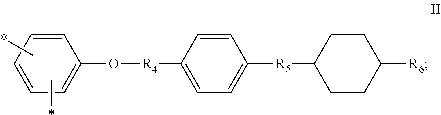

R₄, R₅, and R₆ are independently selected from a single bond, an alkyl group, an alkoxy group, a fluoroalkyl group, or a fluoroalkoxy group, at least two of R₄, R₅, and R₆ are not simultaneously selected from a single bond, and a sum of the number of carbon atoms in R₄, the number of carbon atoms in R₅, and the number of carbon atoms in R₆ is any integer from 2 to 11 at each occurrence;
n represents a positive integer; and
* represents a linking site.

Some embodiments of the present disclosure provide a method for manufacturing a display panel including the following steps:
providing a first substrate and a second substrate;
providing the liquid crystal alignment agent as described above;
applying the liquid crystal alignment agent on the first substrate and/or the second substrate to form a liquid crystal alignment film; and
forming a liquid crystal layer between the first substrate and the second substrate, where the liquid crystal alignment film is disposed close to the liquid crystal layer.

### BRIEF DESCRIPTION OF THE DRAWINGS

In order to explain technical proposals in embodiments of the present disclosure more clearly, the following will briefly introduce the drawings needed to be used in description of the embodiments. Apparently, the drawings in the following description are only some embodiments of the present disclosure. For ordinary skilled in the art, other drawings can be obtained from these drawings without paying creative effort.

In order to understand the present disclosure and beneficial effects thereof more completely, the following will be described in combination with the drawings. In the following description, the same reference numerals indicate the same elements.

FIG. 1 is a schematic cross-sectional structural diagram of a display panel according to some embodiments of the present disclosure.

FIG. 2 is a schematic flowchart of a method for manufacturing a display panel according to some embodiments of the present disclosure.

### DETAILED DESCRIPTION

The following will provide a clear and complete description of the technical proposals in the embodiments of the present disclosure, in conjunction with the drawings.

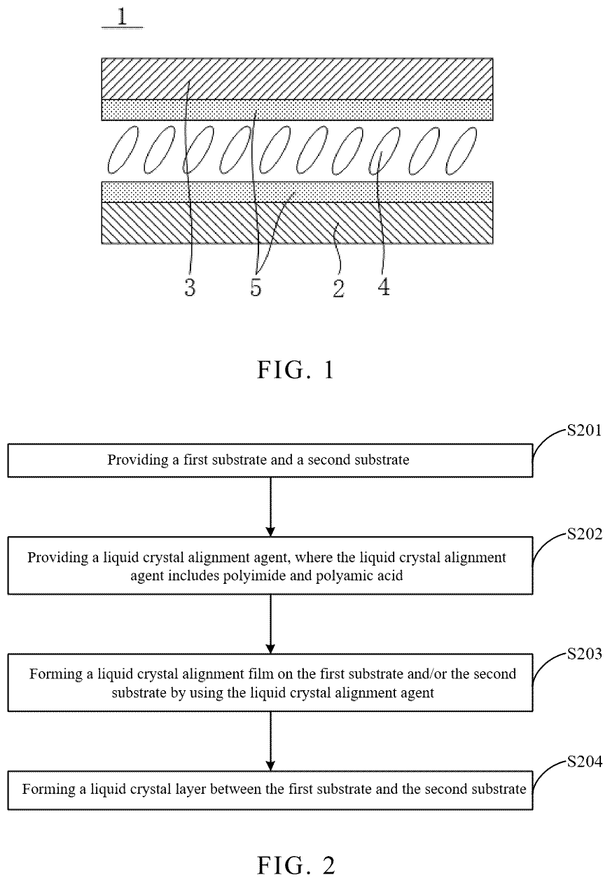

As illustrated in FIG. 1, some embodiments of the present disclosure provide a display panel 1 including a first substrate 2, a second substrate 3, a liquid crystal layer 4, and a liquid crystal alignment film 5. The second substrate 3 and the first substrate 2 are disposed opposite to each other, the liquid crystal layer 4 is disposed between the first substrate 2 and the second substrate 3, and the liquid crystal alignment film 5 is disposed on a side of the first substrate 2 close to the liquid crystal layer 4 and/or a side of the second substrate 3 close to the liquid crystal layer 4. A material of the liquid crystal alignment film 5 includes polyimide represented by the following formula I:

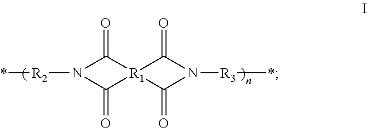

where R₁ represents a group obtained after decarboxylation of a tetracarboxylic dianhydride;
at least one of R₂ and R₃ is represented by the following formula II:

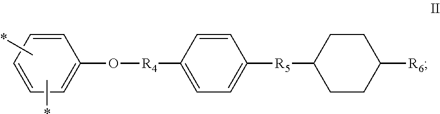

where R₄, R₅, and R₆ are independently selected from a single bond, an alkyl group, an alkoxy group, a fluoroalkyl group, or a fluoroalkoxy group, at least two of R₄, R₅, and R₆ are not simultaneously selected from a single bond, and a sum of the number of carbon atoms in R₄, the number of carbon atoms in R₅, and the number of carbon atoms in R₆ is any integer from 2 to 11 at each occurrence;
n represents a positive integer; and
* represents a linking site.

The above embodiments provide a novel material for the liquid crystal alignment film 5 by improving the chemical structure of polyimide, which can improve the uniformity of the distribution of liquid crystal molecules on the surface of the liquid crystal alignment film 5, thereby alleviating the problem of display non-uniformity such as bright spots.

In the present disclosure, a single bond connected to a substituent group and penetrating a corresponding ring indicates that the substituent group may be connected to any site of the ring. For example,

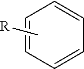

indicates that R may be connected to any substituent site of the benzene ring of the

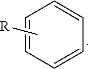

In the above embodiments of the present disclosure, the group represented by the formula II is introduced into the polyimide represented by the formula I as a side chain of the polyimide. Since the group represented by the formula II has a relatively low steric hindrance and an appropriate length, when the polyimide is used as the material of the liquid crystal alignment film 5, the group represented by the formula II can provide good support and have relatively small disturbance to the liquid crystal molecules in the liquid crystal layer 4, which allows the liquid crystal molecules to be uniformly distributed on the surface of the liquid crystal alignment film 5, thereby enhancing the uniformity of the alignment of the liquid crystal molecules at different positions, and alleviating the problem of the display non-uniformity, such as bright spots, caused by non-uniform alignment.

In some embodiments, the display panel 1 includes two liquid crystal alignment films 5 disposed on a side of the first substrate 2 close to the liquid crystal layer 4 and a side of the second substrate 3 close to the liquid crystal layer 4, respectively. As such, the uniformity of the alignment of one of the two liquid crystal alignment films 5 on the first substrate 2 and the uniformity of the alignment of another of the two liquid crystal alignment films 5 on the second substrate 3 are basically consistent, which is conducive to further alleviating the problem of the display non-uniformity such as bright spots.

In some embodiments, R₅ is selected from an alkoxy group, a fluoroalkyl group, or a fluoroalkoxy group, and R₆ is selected from an alkyl group or a fluoroalkyl group. When at least one of R₂ and R₃ is represented by the formula II, R₅ and cyclohexane constitute a body unit of the group represented by the formula II, while the polarity of the group represented by the formula II can be changed by introducing a fluorine atom or an oxygen atom into R₅, which is conducive to increasing affinity of liquid crystals in the liquid crystal layer 4. In addition, R₆ can act as a support unit of the group represented by the formula II, when R₆ is an alkyl group, it can provide better support for the liquid crystal molecules, while when R₆ is a fluoroalkyl group, a fluorine atom introduced into R₆ can modify the group represented by the formula II, so that the liquid crystal molecules can be uniformly distributed on the surface of the liquid crystal alignment film 5, thereby improving the alignment effect of the liquid crystals.

In some embodiments, R₄ is a single bond, but is not limited thereto.

In some embodiments, at least one of R₂ and R₃ is represented by the following formula II-1 or formula II-2:

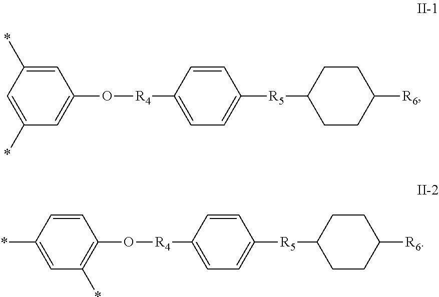

In the above embodiments, definitions of R₄, R₅, and R₆ in the formula II-1 and the formula II-2 are the same as definitions of R₄, R₅, and R₆ in the formula II.

In some embodiments, at least one of R₂ and R₃ is selected from a group consisting of the following groups:

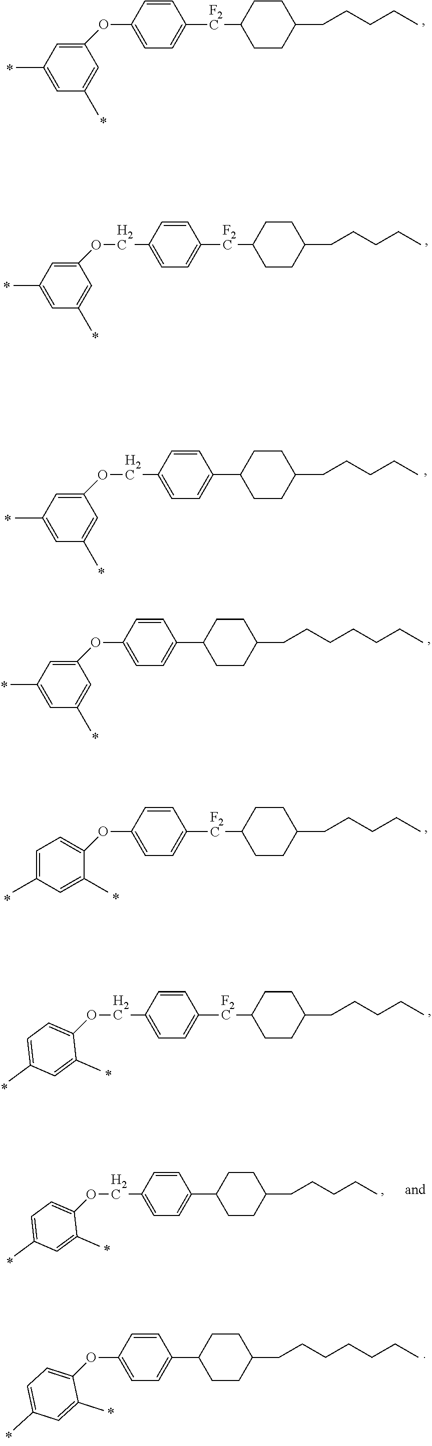

In some embodiments, at least one of R₂ and R₃ is represented by the formula II-1. Since the side chain in the group represented by the formula II-1 has better vertical orientation and a more reasonable spatial angle, it is more conducive to improving the alignment effect of the liquid crystals.

In some embodiments, the polyimide represented by the formula I can be obtained from polyamic acid represented by the following formula III by dehydration cyclization (imidization) reaction.

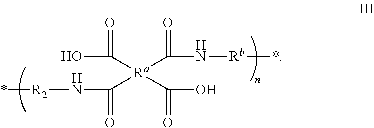

In the above embodiments, definitions of R₁, R₂, R₃, and n in the formula III are the same as definitions of R₁, R₂, R₃, and n in the formula I.

It can be understood that, the polyamic acid represented by the formula III can be obtained by the copolymerization reaction of at least one tetracarboxylic dianhydride and at least one diamine.

In some embodiments, R₁ represents a group obtained after decarboxylation of a tetracarboxylic dianhydride, which may be an aliphatic tetracarboxylic dianhydride, an alicyclic tetracarboxylic dianhydride, or an aromatic tetracarboxylic dianhydride. In some embodiments, R₁ is selected from a group obtained after decarboxylation of the aliphatic tetracarboxylic dianhydride, a group obtained after decarboxylation of the alicyclic tetracarboxylic dianhydride, or a group obtained after decarboxylation of the aromatic tetracarboxylic dianhydride.

Examples of the aliphatic tetracarboxylic dianhydride include, but are not limited to, butane tetracarboxylic dianhydride. Examples of the alicyclic tetracarboxylic dianhydride limited include, but are not to, cyclobutane-1,2,3,4-tetracarboxylic dianhydride (abbreviated as “CBDA”), 2,3,5-tricarboxycyclopentylaceticdianhydride, 1,3,3a,4,5,9b-hexahydro-5-(tetrahydro-2,5-dioxo-3-furyl)-naphtho[1,2-c]furan-1,3-dio ne, 1,3,3a,4,5,9b-hexahydro-8-methyl-5-(tetrahydro-2,5-dioxo-3-furyl)-naphtho[1,2-c]fur an-1,3-dione, 5-(2,5-dioxotetrahydro-3-furanyl)-3-methyl-3-cyclohexene-1,2-dicarboxylic anhydride, 1,2,4,5-cyclohexanetetracarboxylic dianhydride, ethylenediaminetetraacetic dianhydride, cyclopentane tetracarboxylic dianhydride, ethylene glycol bis(anhydro trimellitate), 1,3-propylene glycol bis(anhydro trimellitate), and p-phenylene bis(trimellitic acid monoester anhydride). Examples of the aromatic tetracarboxylic dianhydride include, but are not limited to, pyromelltic acid dianhydride, 3,3′, 4,4′-tetraphenylate dianhydride, 2,2′, 3,3′-biphenyl-tetracarboxylic acid dianhydride, 2,3,3′, 4′-tetraphenylate dianhydride, 3,3′, 4,4′-benzophenonetetracarboxylic dianhydride, 2,3,3′, 4′-benzophenone tetraacid dianhydride, bis(3,4-dicarboxyphenyl) ether dianhydride, bis(3,4-dicarboxyphenyl) sulfone dianhydride, 1,2,5,6-naphthalenetetracarboxylic dianhydride, 2,3,6,7-naphthalenetetracarboxylic dianhydride, and 1,4,5,8-naphthalenetetracarboxylic dianhydride.

In some embodiments, R₁ is a cyclobutyl group, and each of the four carbon atoms in the cyclobutyl group has a linking site. For example, R₁ represents a group obtained after decarboxylation of CBDA, where CBDA has the following chemical structure:

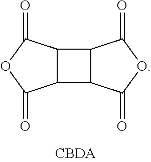 [SMILES: O=C1OC(=O)C2C1C1C(=O)OC(=O)C21]

In some embodiments, R₂ is represented by the formula II, and R₃ is different from R₂.

In some embodiments, R₃ represents a group obtained after deamination of a diamine, which may be an aliphatic diamine, an alicyclic diamine, or an aromatic diamine. In some embodiments, R₃ is selected from a group obtained after deamination of the aliphatic diamine, a group obtained after deamination of the alicyclic diamine, or a group obtained after deamination of the aromatic diamine.

Examples of the aromatic diamine include, but are not limited to, 1,3-bis(aminomethyl)benzene, 1,3-diaminopropane, 1,4-diaminobutane, 1,5-diaminopentane, hexamethylenediamine, and 1,3-bis(aminomethyl)cyclohexane. Examples of the alicyclic diamine include, but are not limited to, 1,4-cyclohexanediamine and 4,4′-methylene bis(cyclohexylamine). Examples of the aromatic diamine include, but are not limited to, dodecyloxydiaminobenzene, tetradecyloxydiaminobenzene, pentadecyloxydiaminobenzene, hexadecyloxydiaminobenzene, octadecyloxydiaminobenzene, cholesteralkoxy diamino benzene, cholestenoxy diamino benzene, diaminobenzoic acid cholesteryl ester, diaminobenzoic acid cholestenyl ester, diaminobenzoic acid lanosteryl ester, 3,6-bis(4-aminobenzoyloxy) cholesterane, 3,6-bis(4-aminophenoxy) cholesterane, 1,1-bis(4-((aminophenyl)methyl)phenyl)-4-butylcyclohexane, 1,1-bis(4-((aminophenyl)methyl)phenyl)-4-heptylcyclohexane, 1,1-bis(4-((aminophenoxy)methyl)phenyl)-4-heptylcyclohexane, 1,1-bis(4-((aminophenyl)methyl)phenyl)-4-(4-heptylcyclohexyl) N-(2,4-diaminophenyl)-4-(4-heptylcyclohexyl)benzamide, cyclohexane, p-phenylenediamine, 4,4′-methylenedianiline (abbreviated as “MDA”), 4,4′-diaminodiphenyl sulfide, 4-aminophenyl-4′-aminobenzoate, (E)-4,4′-aminoazobenzene, 1,7-bis(4-aminophenoxy) heptane, 1,5-bis(4-aminophenoxy) pentane, bis[2-(4-aminophenyl)ethyl] adipate, N,N-bis(4-aminophenyl)methylamine, 1,5-naphthalenediamine, 2,2′-dimethyl-4,4′-diaminobiphenyl, 2,2′-bis(trifluoromethyl)benzidine, 2,7-diaminofluorene, 4,4′-oxydianiline, 2,2-bis[4-(4-aminophenoxy)phenyl]propane, 9,9-bis(4-aminophenyl) fluorine, 2,2-bis[4-(4-aminophenoxy)phenyl]hexafluoropropane, 2,2-bis(4-aminophenyl) hexafluoropropane, 4,4′-(p-phenylenediisopropylidene)diphenylamine, 4,4′-(m-phenylenediisopropylidene)diphenylamine, 1,4-bis(4-aminophenoxy)benzene, 4,4′-bis(4-aminophenoxy) biphenyl, 3,6-diaminocarbazole, 2,3-diaminopyridine, 2,6-diaminopyridine, 3,4-diaminopyridine, 2,4-diaminopyrimidine, 2,4-diamino-6-hydroxypyrimidine, 2,4-diamino-1,3,5-triazine, 2,6-diaminopurine, and 3,5-diamino-1,3,5-triazole.

In some embodiments, R₃ represents a group obtained after deamination of MDA, where MDA has the following chemical structure:

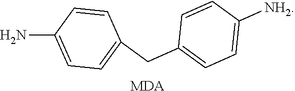

In some embodiments, the material of the liquid crystal alignment film 5 includes polyimide represented by the following formula I-1 or formula I-2:

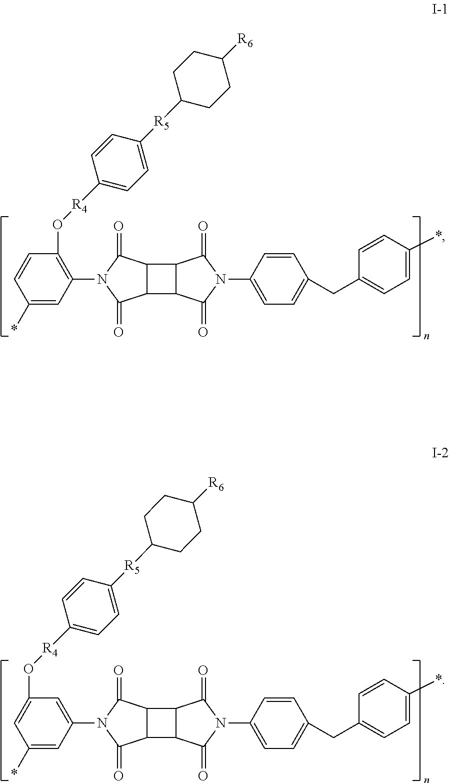

In the above embodiments, definitions of R₄, R₅, and R₆ in the formula I-1 and the formula I-2 are the same as definitions of R₄, R₅, and R₆ in the formula II, and n represents a positive integer.

In some embodiments, the polyimide represented by the formula I-1 and the polyimide represented by the formula I-2 are prepared from raw materials composed of CBDA, MDA, and two types of side-chain diamines, respectively, where the two types of side-chain diamines are represented by the following formulae:

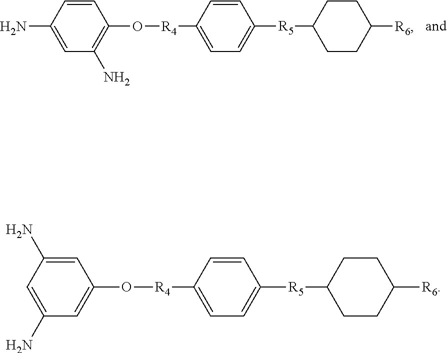

In the above embodiments, definitions of R₄, R₅, and R₆ in the two formulae above are the same as definitions of R₄, R₅, and R₆ in the formula II.

In some embodiments, the first substrate 2 is an array substrate and the second substrate 3 is a color filter substrate (a counter substrate), but are not limited thereto.

In some embodiments, a side of the second substrate 3 facing the first substrate 2 is provided with support pillars extending into the liquid crystal layer 4, and the liquid crystal alignment film 5 may be provided avoiding the support pillars.

It can be understood that, the embodiments of the present disclosure do not limit the structures of the first substrate 2 and the second substrate 3.

In some embodiments, the display panel 1 is a vertical alignment (VA) type of liquid crystal display panel, a twisted nematic (TN) type of liquid crystal display panel, or an in-plane switching (IPS) type of liquid crystal display panel, but is not limited thereto.

In the above embodiments of the present disclosure, the group represented by the formula II is introduced into the polyimide represented by the formula I as a side chain of the polyimide. Since the group represented by the formula II has a relatively low steric hindrance and an appropriate length, when the polyimide is used as the material of the liquid crystal alignment film 5, the group represented by the formula II can provide good support and have relatively small disturbance to the liquid crystal molecules in the liquid crystal layer 4, which allows the liquid crystal molecules to be uniformly distributed on the surface of the liquid crystal alignment film 5, thereby enhancing the uniformity of the alignment of the liquid crystal molecules at different positions, and improving the problem of the display non-uniformity, such as bright spots, caused by non-uniform alignment.

Some embodiments of the present disclosure further provide a liquid crystal alignment agent, which includes at least one of polyimide represented by the following formula I or polyamic acid represented by the following formula III:

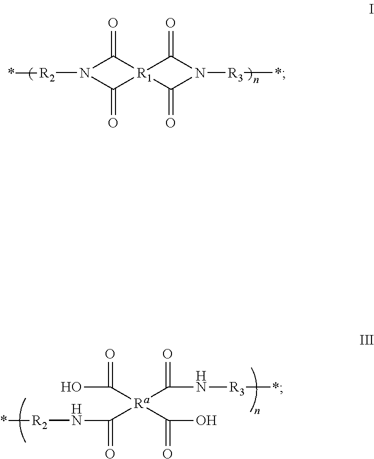

where R₁ represents a group obtained after decarboxylation of a tetracarboxylic dianhydride;
at least one of R₂ and R₃ is represented by the following formula II:

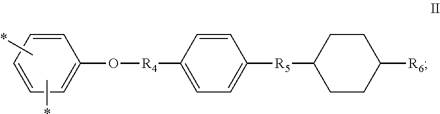

where R₄, R₅, and R₆ are independently selected from a single bond, an alkyl group, an alkoxy group, a fluoroalkyl group, or a fluoroalkoxy group, at least two of R₄, R₅, and R₆ are not simultaneously selected from a single bond, and a sum of the number of carbon atoms in R₄, the number of carbon atoms in R₅, and the number of carbon atoms in R₆ is any integer from 2 to 11 at each occurrence;
n represents a positive integer; and
* represents a linking site.

It can be understood that, the polyamic acid represented by the formula III may be a precursor of the polyimide represented by the formula I. That is, the polyimide represented by the formula I can be obtained from the polyamic acid represented by the formula III by dehydration cyclization (imidization) reaction.

In some embodiments, R₅ is selected from an alkoxy group, a fluoroalkyl group, or a fluoroalkoxy group, and R₆ is selected from an alkyl group or a fluoroalkyl group. When at least one of R₂ and R₃ is represented by the formula II, R₅ and cyclohexane constitute a body unit of the group represented by the formula II, while the polarity of the group represented by the formula II can be changed by introducing a fluorine atom or an oxygen atom into R₅, which is conducive to increasing affinity of liquid crystals in the liquid crystal layer 4. In addition, R₆ can act as a support unit of the group represented by the formula II, when R₆ is an alkyl group, it can provide better support for the liquid crystal molecules, while when R₆ is a fluoroalkyl group, a fluorine atom introduced into R₆ can modify the group represented by the formula II, so that the liquid crystal molecules can be uniformly distributed on the surface of the liquid crystal alignment film 5, thereby improving the alignment effect of the liquid crystals.

In some embodiments, R₄ is a single bond, but is not limited thereto.

In some embodiments, the material of the liquid crystal alignment agent further includes one or more intermediates synthesized in the imidization process of the polyamic acid represented by the formula III. For example, the intermediate is at least one selected from compounds represented by the following formula V or formula VI:

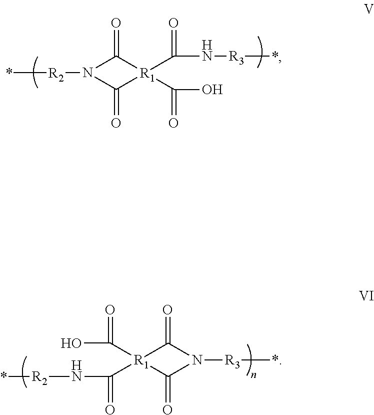

In the above embodiments, definitions of R₁, R₂, R₃, and n in the formula V and the formula VI are the same as definitions of R₁, R₂, R₃, and n in the formula I.

In some embodiments, at least one of R₂ and R₃ is represented by the following formula II-1 or formula II-2:

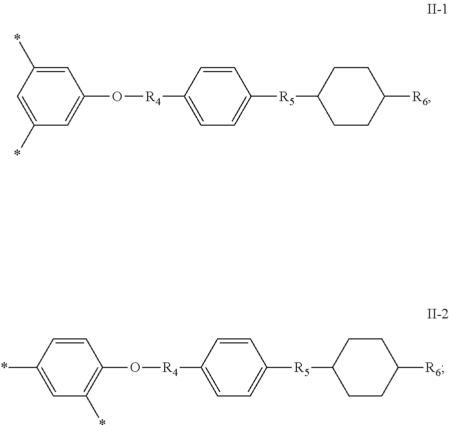

In the above embodiments, definitions of R₄, R₅, and R₆ in the formula II-1 and formula II-2 are the same as definitions of R₄, R₅, and R₆ in the formula II.

In some embodiments, at least one of R₂ and R₃ is selected from a group consisting of the following groups:

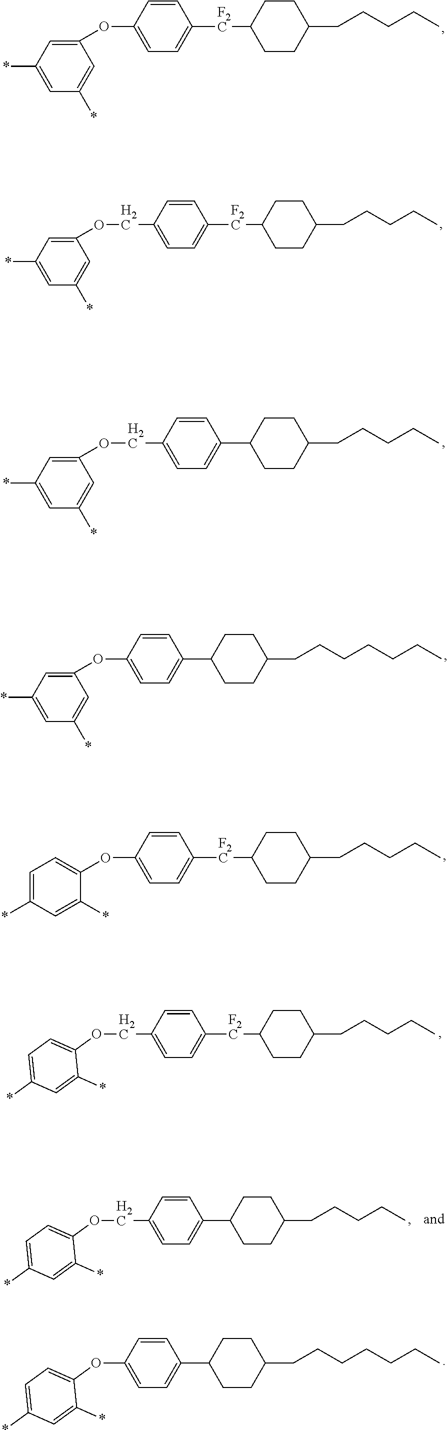

In some embodiments, at least one of R₂ and R₃ is represented by the formula II-1. Since the side chain in the group represented by the formula II-1 has better vertical orientation and a more reasonable spatial angle, it is more conducive to improving the alignment effect of the liquid crystals.

In some embodiments, R₁ represents a group obtained after decarboxylation of a tetracarboxylic dianhydride, which may be an aliphatic tetracarboxylic dianhydride, an alicyclic tetracarboxylic dianhydride, or an aromatic tetracarboxylic dianhydride. In some embodiments, R₁ is selected from a group obtained after decarboxylation of the aliphatic tetracarboxylic dianhydride, a group obtained after decarboxylation of the alicyclic tetracarboxylic dianhydride, or a group obtained after decarboxylation of the aromatic tetracarboxylic dianhydride. Examples of the aliphatic tetracarboxylic dianhydride, the alicyclic tetracarboxylic dianhydride, and the aromatic tetracarboxylic dianhydride can refer to the description of the above-mentioned embodiments, and will not be repeated herein.

In some embodiments, R₂ is represented by the formula II, and R₃ is different from R₂.

In some embodiments, R₃ represents a group obtained after deamination of a diamine, which may be an aliphatic diamine, an alicyclic diamine, or an aromatic diamine. In some embodiments, R₃ is selected from a group obtained after deamination of the aliphatic diamine, a group obtained after deamination of the alicyclic diamine, or a group obtained after deamination of the aromatic diamine. Examples of the aliphatic diamine, the alicyclic diamine, and the aromatic diamine can refer to the description of the above-mentioned embodiments, and will not be repeated herein.

In some embodiments, R₁ represents a group obtained after decarboxylation of CBDA, and R₃ represents a group obtained after deamination of MDA.

In some embodiments, the liquid crystal alignment agent includes at least one of polyimide represented by the following formula I-1, polyimide represented by the following formula I-2, polyamic acid represented by the following formula III-1, or polyamic acid represented by the following formula III-2:

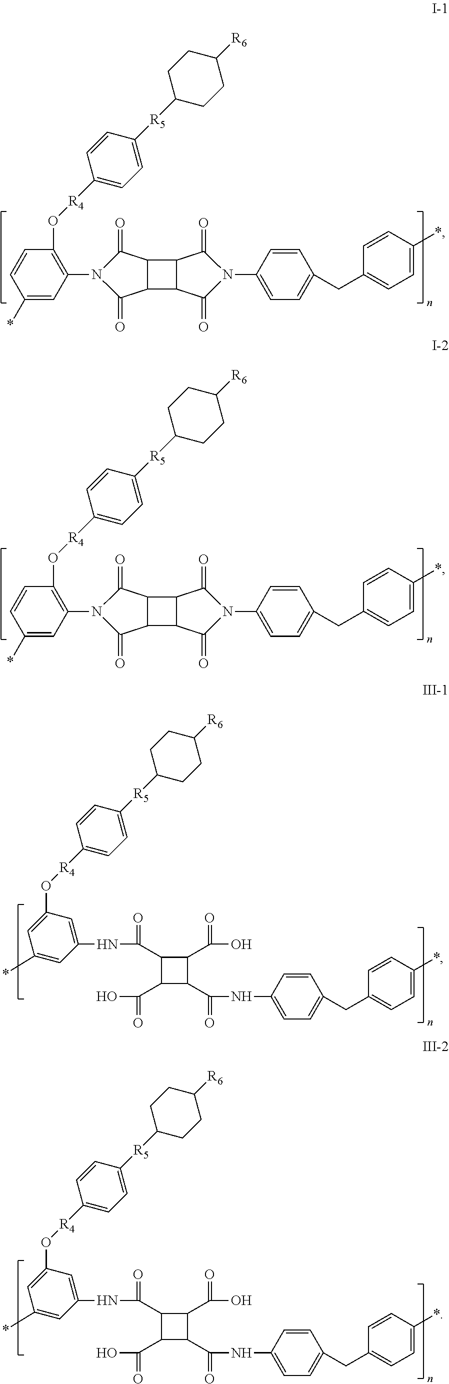

In the above embodiments, definitions of R₄, R₅, and R₆ in the formulae I-1, I-2, III-1, and III-2 are the same as definitions of R₄, R₅, and R₆ in the formula II, and n represents a positive integer.

In some embodiments, the liquid crystal alignment agent further includes one or more organic solvents. Examples of the organic solvents include, but are not limited to, N-methylpyrrolidone (abbreviated as “NMP”), N-ethylpyrrolidone (abbreviated as “NEP”), butyl carbonate (abbreviated as “BC”), diethylene glycol monoethyl ether (abbreviated as “DEDG”), and diacetone alcohol (abbreviated as “DAA”).

In the above embodiments of the present disclosure, physical parameters, such as the solid content of polyimide in the liquid crystal alignment agent and the viscosity of the liquid crystal alignment agent, can be adjusted by the addition of the one or more organic solvents. As such, it is conducive to improving the film-forming effect of the liquid crystal alignment agent.

In some embodiments, examples of the organic solvents further include, but are not limited to, N-methyl-2-pyrrolidone, 1,4-butyrolactone, pyrrolidinone, N,N-dimethylformamide, N,N-dimethylacetamide, diacetone alcohol, 2-methoxyethanol, butyl lactate, butyl acetate, methyl methoxypropionate, ethyl ethoxypropionate, 2-methoxyethanol, 2-ethoxyethanol, 2-propoxyethanol, 2-isopropoxyethanol, 2-butoxyethanol, 1,2-dimethoxyethane, ethyl ethoxyacetate, diglyme, diethylene glycol diethyl ether, diethylene glycol monomethyl ether, diethylene glycol monoethyl ether, diethylene glycol monomethyl ether acetate, diethylene glycol monoethyl ether acetate, 2,6-dimethyl-4-heptanone, isoamyl propionate, isopentyl isobutyrate, isopentyl ether, ethylene carbonate, and polypropylene carbonate.

In some embodiments, the liquid crystal alignment agent further includes an additive for further adjusting the physical parameters of the liquid crystal alignment agent, so that the film-forming effect of the liquid crystal alignment can meet the demands.

In some embodiments, the liquid crystal alignment film 5 of the display panel 1 described in the above-mentioned embodiments can be prepared by using the liquid crystal alignment agent provided in the embodiments of the present disclosure.

In the above embodiments of the present disclosure, the group represented by the formula II is introduced into both the polyimide represented by the formula I and the polyamic acid represented by the formula III. When the liquid crystal alignment agent containing the polyimide represented by the formula I and/or the polyamic acid represented by the formula III is used to prepare a liquid crystal alignment film, since the group represented by the formula II has a relatively low steric hindrance and an appropriate length, and the group represented by the formula II can provide good support and have relatively small disturbance to the liquid crystal molecules, the liquid crystal alignment film containing the group represented by the formula II can provide good support and have relatively small disturbance to the liquid crystal molecules in the liquid crystal layer, so that the liquid crystal molecules can be uniformly distributed on the surface of the liquid crystal alignment film, thereby enhancing the uniformity of the alignment of the liquid crystal molecules at different positions, and alleviating the problem of the display non-uniformity, such as bright spots, caused by non-uniform alignment.

As illustrated in FIG. 1 and FIG. 2, some embodiments of the present disclosure provide a method for manufacturing the display panel 1, which includes the following steps S201 to S204.

In step S201, a first substrate and a second substrate are provided.

In some embodiments, as illustrated in FIG. 1, the first substrate 2 is an array substrate, and the second substrate 3 is a color filter substrate (a counter substrate), but are not limited thereto. It can be understood that, the present disclosure does not limit the structures of the first substrate 2 and the second substrate 3.

In step S202, a liquid crystal alignment agent is provided. The liquid crystal alignment agent includes at least one of the polyimide represented by the formula I or the polyamic acid represented by the formula III.

In some embodiments, the liquid crystal alignment agent includes the polyimide represented by the formula I, and a step of preparing the liquid crystal alignment agent includes the following steps:
adding at least one tetracarboxylic dianhydride and at least one diamine to a first organic solvent system to obtain a polyamic acid solution by reaction at a preset temperature;
forming a polyimide solution by dehydrative cyclization reaction of polyamic acid in the polyamic acid solution; and
extracting polyimide from the polyimide solution, and adding the polyimide to a second organic solvent system to obtain the liquid crystal alignment agent.

The at least one diamine includes a side-chain diamine represented by the following formula IV:

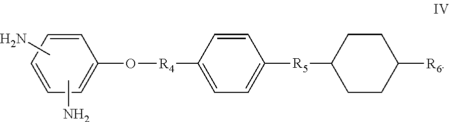

The definitions of R₄, R₅, and R₆ in the formula IV are the same as definitions of R₄, R₅, and R₆ in the formula II.

In some embodiments, the side-chain diamine is at least one selected from diamines represented by the following formula IV-1 or formula IV-2:

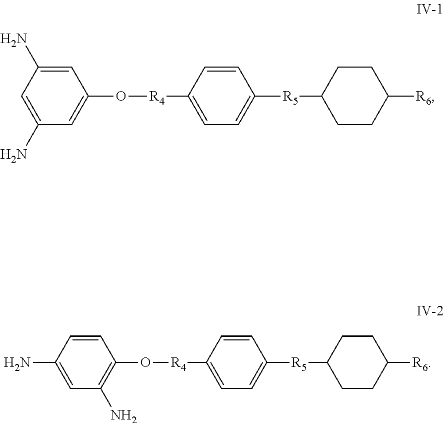

In the above embodiments, definitions of R₄, R₅, and R₆ in the formula IV-1 and the formula IV-2 are the same as definitions of R₄, R₅, and R₆ in the formula II.

In some embodiments, the side-chain diamine is at least one selected from a group consisting of the following compounds IV-1-1 to IV-2-4:

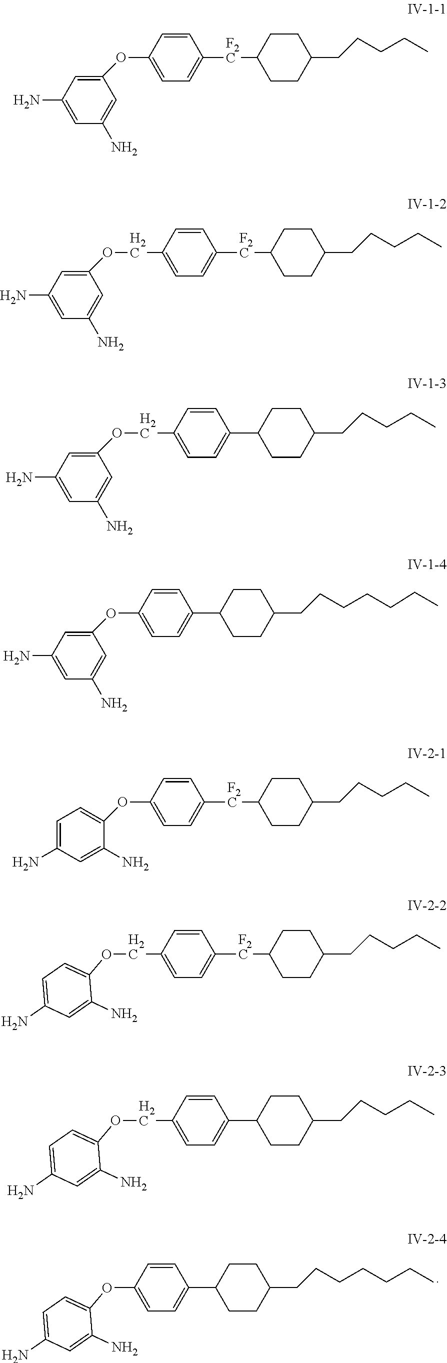

In some embodiments, a molar percentage of the side-chain diamine in a solution composed of the at least one tetracarboxylic dianhydride and the at least one diamine is greater than or equal to 10% and less than or equal to 20%.

For example, the molar percentage of the side-chain diamine in the solution composed of the at least one tetracarboxylic dianhydride and the at least one diamine is 10%, 11%, 12%, 13%, 14%, 15%, 16%, 17%, 18%, 19%, or 20%.

In some embodiments, a molar percentage of the at least one tetracarboxylic dianhydride in the solution composed of the at least one tetracarboxylic dianhydride and the at least one diamine is equal to 50%.

In some embodiments, the at least one tetracarboxylic dianhydride includes CBDA, and the at least one diamine further includes MDA.

In some embodiments, raw materials mixed into the first organic solvent system include the side-chain diamine represented by the formula IV, CBDA, and MDA. Based on the total molar amount of the raw materials, the molar percentage of CBDA in the raw materials is equal to 50%, the molar percentage of the side-chain diamine represented by the formula IV in the raw materials is defined as x, the molar percentage of MDA in the raw materials is defined as y, x is greater than or equal to 10% and less than or equal to 20%, and y and x satisfy the following equation: y=50%-x.

In some embodiments, the first organic solvent system includes NMP with a solid content of 30% in the first organic solvent system.

In some embodiments, the preset temperature is 25° C. It can be understood that, the preset temperature can be adjusted according to actual conditions.

In some embodiments, the step of forming the polyimide solution by dehydrative cyclization reaction of polyamic acid in the polyamic acid solution includes the following steps:
adding NMP to the polyamic acid solution to dilute the polyamic acid solution to a mass percentage of approximately 6% of polyamic acid; and
adding an appropriate amount of acetic anhydride and pyridine to the diluted polyamic acid solution, and reacting at 100° C. to obtain a polyimide solution.

In some embodiments, after adding acetic anhydride and pyridine to the diluted polyamic acid solution, the molar ratio of polyamic acid, acetic anhydride, and pyridine is 1:1:0.8, but is not limited thereto.

In the embodiments of the present disclosure, the polyimide is obtained by the dehydrative cyclization reaction of the polyamic acid using a catalyst. In some other embodiments, the polyimide is obtained by the dehydrative cyclization reaction of the polyamic acid under heating.

In some embodiments, methods for extracting polyimide from the polyimide solution includes adding formaldehyde to the polyimide solution to precipitate the polyimide, but are not limited thereto.

In some embodiments, the second organic solvent system includes at least one of NMP, NEP, BC, DEDG, or DAA. The volume ratio of NMP, NEP, BC, DEDG, and DAA in the second organic solvent system is 30:15:35:10:10, but is not limited thereto.

In step S203, a liquid crystal alignment film is formed on the first substrate and/or the second substrate by using the liquid crystal alignment agent.

In some embodiments, the liquid crystal alignment agent is coated on the first substrate 2 and/or the second substrate 3 by a spin-coating process, then heated and baked to form the liquid crystal alignment film 5.

In step S204, the first substrate and the second substrate are placed opposite to each other, and a liquid crystal layer is formed between the first substrate and the second substrate. The liquid crystal alignment film is disposed close to the liquid crystal layer.

In some embodiments, when the first substrate 2 and the second substrate 3 are disposed opposite to each other, the edge of the first substrate 2 and the edge of the second substrate 3 are fixedly connected by a border adhesive.

In some embodiments, the liquid crystal layer 4 is formed by a one drop fill (ODF) process for liquid crystals, but is not limited thereto.

The present disclosure further provides a comparative example and examples 1-9 to verify the bright spots of test panels obtained from these examples, and the test panels provided in the comparative example and examples 1-9 were continuously lit up in the test.

### Comparative Example

### (1) Preparation of Liquid Crystal Alignment Agent

The side-chain diamine used in the comparative example is 1,3-diamino-4-{4-(trans-4-(trans-4-n-pentylcyclohexyl)cyclohexyl) phenoxy}benzene, (abbreviated as “PBCH5DAB”) having the following chemical structure:

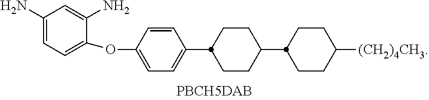

The process for preparing the liquid crystal aligning agent of the comparative example was as follows: a three-necked flask was flushed with argon for 15 minutes in a flow rate of 0.1 L/min to 1 L/min. Then a NMP solution with a solid content of 30% was added to the three-necked flask, and a mixture of CBDA, MDA, and PBCH5DAB with a molar ratio of 50:20:30 was added to the NMP solution to obtain a reaction solution, which was reacted at 25° C. for 4 hours to obtain a polyamic acid solution. NMP was added to the polyamic acid solution to dilute the polyamic acid solution to a solid content of approximately 6%, then an appropriate amount of acetic anhydride and pyridine (catalyst) were added to the polyamic acid solution, where the molar ratio of polyamic acid, acetic anhydride, and pyridine was 1:1:0.8. Subsequently, the reaction solution was reacted at 100° C. for 3 hours, then methanol was added to the reaction solution to obtain polyimide in the form of a white powder. Finally, the polyimide was added to a mixed solvent of NMP, NEP, BC, DEDG, and DAA with a volume ratio of 30:15:35:10:10 to obtain the liquid crystal alignment agent.

### (2) Preparation of Liquid Crystal Alignment Film

The liquid crystal alignment agent was coated on the array substrate having driving electrodes thereon and the color filter substrate having support pillars thereon by a spin-coating process, then the array substrate and the color filter substrate coated with the liquid crystal alignment agent were baked on a hot plate at 80° C. for 120 seconds, and baked in a hot air circulation furnace at 185° C. for 1200 seconds, to obtain a liquid crystal alignment film with a thickness of 95 nm to 105 nm.

### (3) Preparation of Test Panel

The border adhesive doped with silicon spheres with a diameter of 3.6 μm was coated on the periphery of the array substrate by using a coater, liquid crystals were dripped on the surface of the array substrate by using a pipette to present an arrangement of matrix, then the array substrate and the color filter substrate were aligned at 120° C. for 2 minutes by using a hot press. Finally, voltage was applied to the two substrates, and the two substrates were irradiated with ultraviolet (UV) light to complete the alignment, to obtain a test panel No. 1.

### Examples 1 to 9

Test panels No. 2 to No. 10 provided in the examples 1 to 9 were obtained according to the method for preparing the test panel No. 1 provided in the comparative example.

The examples 1 to 9 were different from the comparative example in that the side-chain diamines used were the compound IV-1-1, instead of PBCH5DAB used in the comparative example. As such, in the method for preparing the polyamic acid solution of each of the examples 1 to 9, compound IV-1-1, CBDA, and MDA were added to the NMP solution with a solid content of 30%. Moreover, based on a total molar amount of a mixture of the compound IV-1-1, CBDA, and MDA, a molar percentage of CBDA in the mixture is equal to 50%, a molar percentage of the compound IV-1-1 in the mixture is defined as x, and a molar percentage of MDA in the mixture is defined as y, x is greater than or equal to 10% and less than or equal to 20%, and y and x satisfy the following equation: y=50%-x.

The compound IV-1-1 has the following chemical structure:

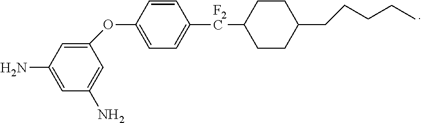 [SMILES: CCCCCC1CCC(C(F)(F)c2ccc(Oc3cc(N)cc(N)c3)cc2)CC1]

The compounds IV-1-1 used in the examples 1 to 9 have different molar percentages. Specifically, the molar percentages x of the compounds IV-1-1 used in examples 1 to 9 are 0.5%, 1%, 3%, 5%, 10%, 15%, 20%, 25%, and 30%, respectively. Correspondingly, the molar percentages y of MDA used in examples 1 to 9 are 49.5%, 49%, 47%, 45%, 40%, 35%, 30%, 25%, and 20%, respectively.

Furthermore, in the present disclosure, the test panels No. 1 to No. 10, provided in the comparative example and the examples 1 to 9, were continuously lit up for 72 hours with a DC voltage of 5 V, respectively, and the bright spots level of each test panel was determined using crossed polarizers, obtaining the results shown in Table 1.

TABLE 1

| Test | Side-chain | Molar | Bright |
|---|---|---|---|
| panel | diamine | percentage x | spots level |
| No. 1 | PBCH5DAB | 30 | x |
| No. 2 | Compound IV-1-1 | 0.5% | x |
| No. 3 | Compound IV-1-1 | 1% | x |
| No. 4 | Compound IV-1-1 | 3% | x |
| No. 5 | Compound IV-1-1 | 5% | Δ |
| No. 6 | Compound IV-1-1 | 10% | ∘ |
| No. 7 | Compound IV-1-1 | 15% | ∘ |
| No. 8 | Compound IV-1-1 | 20% | ∘ |
| No. 9 | Compound IV-1-1 | 25% | Δ |
| No. 10 | Compound IV-1-1 | 30% | Δ |

In Table 1, the symbol “x” represents poor bright spots level, that is, more bright spots with high brightness can be observed under the crossed polarizer, indicating that the uniformity of the alignment of the liquid crystals is poor; the symbol “A” represents medium bright spots level, that is, more bright spots with low brightness can be observed under the crossed polarizer, indicating that the uniformity of the alignment of the liquid crystals is at a medium level; and the symbol “o” represents good bright spots level, that is, no bright spots can be observed under the crossed polarizer, indicating that the uniformity of the alignment of the liquid crystals is better.

As can be seen from Table 1, when the liquid crystal alignment film is prepared using the liquid crystal alignment agent provided in the examples 1 to 9 of the present disclosure, in the process of preparing the liquid crystal alignment agent, the molar percentage of the compound IV-1-1 was controlled in the range of 5% to 30%, which can improve the problem of display non-uniformity such as bright spots. In addition, in the process of preparing the liquid crystal alignment agent, the molar percentage of the compound IV-1-1 was controlled in the range of 10% to 20%, which can significantly improve the problem of the display non-uniformity such as the bright spots.

An example of the present disclosure provides a method for synthesizing the compound IV-1-1. The synthesis route of the compound IV-1-1 is as follows:

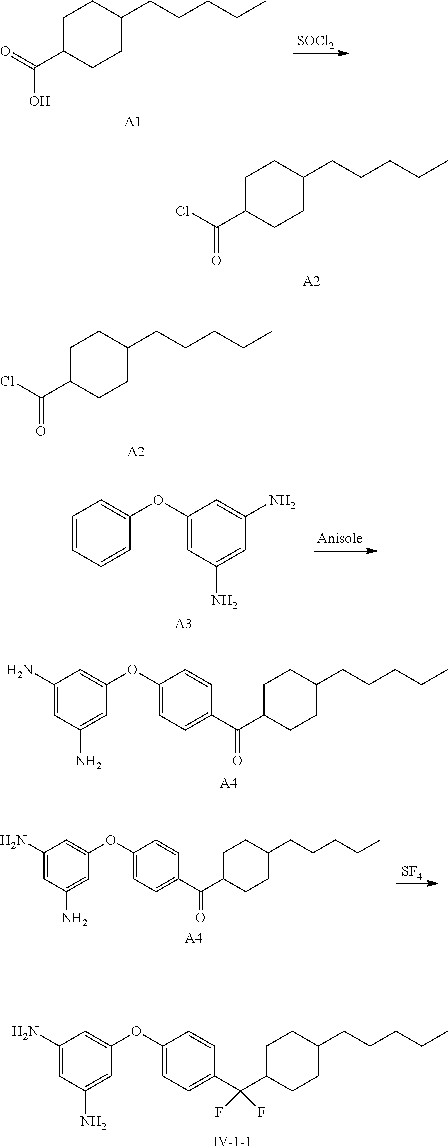

The method for synthesizing the compound IV-1-1 is as follows.

### (1) Synthesis of Intermediate A2

Compound A1 (200 mmol) was added to a round-bottom flask, gas in the round-bottom flask was replaced three times with nitrogen (N₂), then SOCl₂ (150 mmol) was added to the round-bottom flask to obtain a reaction solution. The reaction solution was heated to 80° C. under N₂ atmosphere and refluxed to obtain the intermediate A2 with a yield of 95%.

### (2) Synthesis of Intermediate A4

The intermediate A2 (190 mmol) was added to a round-bottom flask, anisole (120 ml) was added thereto, and the round-bottom flask was placed in an ice bath and maintained the temperature below 18° C. Then compound A3 (200 mmol) was added to the round bottom flask containing the intermediate A2 to obtain a reaction solution, which was stirred and reacted for 3.5 hours. After the reaction was completed, the reaction solution was poured into ice water (200 mL), the aqueous layer in the reaction solution was extracted twice with CH₂Cl₂, and the organic layer in the reaction solution was washed with a mixture of water and 2% of NaOH solution and dried. Anisole in the organic layer was removed in vacuo to obtain the intermediate A4 with a yield of 73%.

### (3) Synthesis of Compound IV-1-1

The intermediate A4 (138 mmol) was added to a round bottom flask, DMF was added to dissolve the intermediate A4, then SF₄ was introduced into the round-bottom flask at a rate of 20 mL/min. After the reaction was completed, a back-extraction of the reaction solution was performed by using ethyl acetate, then the reaction solution was washed with a saturated NaCl solution and dried with Na₂SO₄. Subsequently, the reaction solution was dried by rotary evaporation and purified by column chromatography to obtain the compound IV-1-1 with a yield of 83%.

In the above embodiments of the present disclosure, the group represented by the formula II is introduced into the polyimide represented by the formula I as a side chain of the polyimide. Since the group represented by the formula II has a relatively low steric hindrance and an appropriate length, when the polyimide is used as the material of the liquid crystal alignment film, the group represented by the formula II can provide good support and have relatively small disturbance to the liquid crystal molecules in the liquid crystal layer, which allows the liquid crystal molecules to be uniformly distributed on the surface of the liquid crystal alignment film, thereby enhancing the uniformity of the alignment of the liquid crystal molecules at different positions, and alleviating the problem of the display non-uniformity, such as bright spots, caused by non-uniform alignment.

In the present disclosure, the terms “first” and “second” are used only for the purpose of description, and cannot be understood as indicating or implying relative importance or implying the number of features indicated. Therefore, the features limited to “first” and “second” may explicitly or implicitly include one or more features. Moreover, the term “a plurality of” refers to two or more than two, unless otherwise specified.

In the above embodiments, the description of each embodiment has its own emphasis, and for parts not described in detail in a certain embodiment, please refer to relevant description of other embodiments.

The embodiments, examples, and related technical features of the present disclosure may be combined and replaced with each other without conflict.

The above are merely preferred embodiments of the present disclosure, and do not limit the present disclosure in any form. Any simple modifications, equivalent changes, and modifications made to the above embodiments according to the technical essence of the present disclosure without departing from the contents of the technical proposals of the present disclosure still fall within the scope of the technical proposals of the present disclosure.

What is claimed is:

1. A display panel, comprising:
a first substrate;
a second substrate disposed opposite to the first substrate;
a liquid crystal layer disposed between the first substrate and the second substrate; and
a liquid crystal alignment film disposed on a side of the first substrate close to the liquid crystal layer and/or a side of the second substrate close to the liquid crystal layer, wherein a material of the liquid crystal alignment film comprises polyimide represented by formula I: 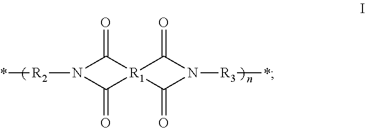
wherein R₁ represents a group obtained after decarboxylation of a tetracarboxylic dianhydride;
at least one of R₂ and R₃ is represented by formula II: 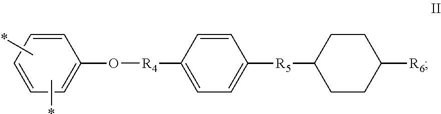
R₄, R₅, and R₆ are independently selected from a single bond, an alkyl group, an alkoxy group, a fluoroalkyl group, or a fluoroalkoxy group, at least two of R₄, R₅, and R₆ are not simultaneously selected from a single bond, and a sum of the number of carbon atoms in R₄, the number of carbon atoms in R₅, and the number of carbon atoms in R₆ is any integer from 2 to 11 at each occurrence;
n represents a positive integer; and
* represents a linking site.

2. The display panel according to claim 1, wherein R₅ is selected from an alkoxy group, a fluoroalkyl group, or a fluoroalkoxy group, and R₆ is selected from an alkyl group or a fluoroalkyl group.

3. The display panel according to claim 1, wherein at least one of R₂ and R₃ is represented by formula II-1 or formula II-2: 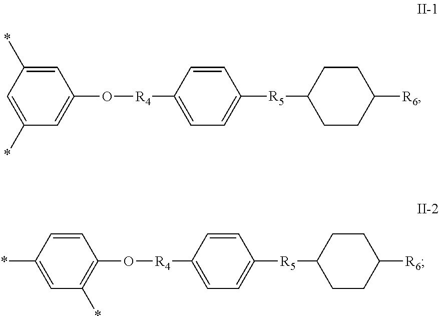
wherein definitions of R₄, R₅, and R₆ in the formula II-1 and the formula II-2 are the same as definitions of R₄, R₅, and R₆ in the formula II.

4. The display panel according to claim 1, wherein at least one of R₂ and R₃ is selected from a group consisting of:

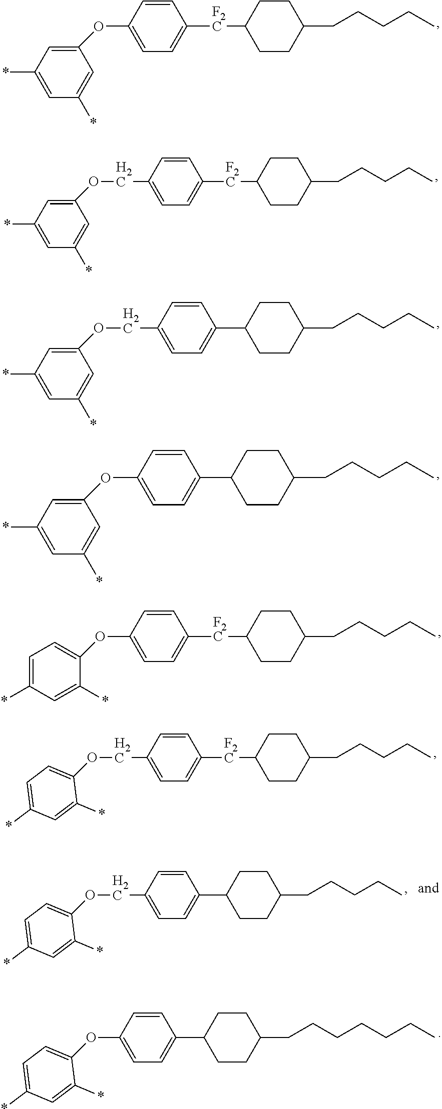

5. The display panel according to claim 1, wherein R₁ is selected from a group obtained after decarboxylation of an aliphatic tetracarboxylic dianhydride, a group obtained after decarboxylation of an alicyclic tetracarboxylic dianhydride, or a group obtained after decarboxylation of an aromatic tetracarboxylic dianhydride; and
wherein R₂ is represented by the formula II, and R₃ is different from R₂ and selected from a group obtained after deamination of an aliphatic diamine, a group obtained after deamination of an alicyclic diamine, or a group obtained after deamination of an aromatic diamine.

6. The display panel according to claim 5, wherein the polyimide is represented by formula I-1 or formula I-2: 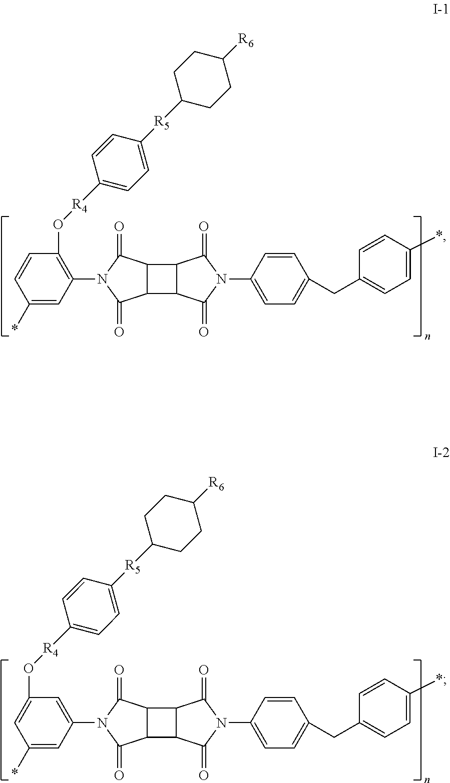
wherein definitions of R₄, R₅, and R₆ in the formula I-1 and the formula I-2 are the same as definitions of R₄, R₅, and R₆ in the formula II; and
n represents a positive integer.

7. A liquid crystal alignment agent comprising at least one of polyimide represented by formula I or polyamic acid represented by formula III: 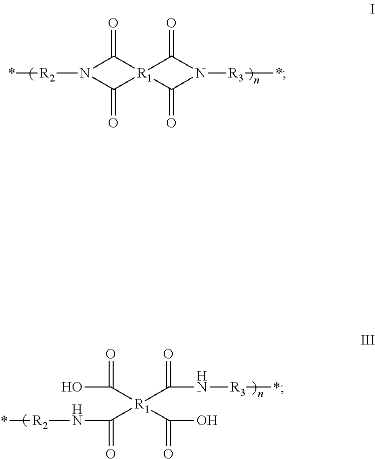
wherein R₁ represents a group obtained after decarboxylation of a tetracarboxylic dianhydride;
at least one of R₂ and R₃ is represented by formula II: 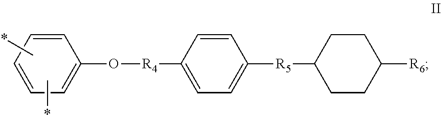
R₄, R₅, and R₆ are independently selected from a single bond, an alkyl group, an alkoxy group, a fluoroalkyl group, or a fluoroalkoxy group, at least two of R₄, R₅, and R₆ are not simultaneously selected from a single bond, and a sum of the number of carbon atoms in R₄, the number of carbon atoms in R₅, and the number of carbon atoms in R₆ is any integer from 2 to 11 at each occurrence;
n represents a positive integer; and
* represents a linking site.

8. The liquid crystal alignment agent according to claim 7, wherein at least one of R₂ and R₃ is represented by formula II-1 or formula II-2: 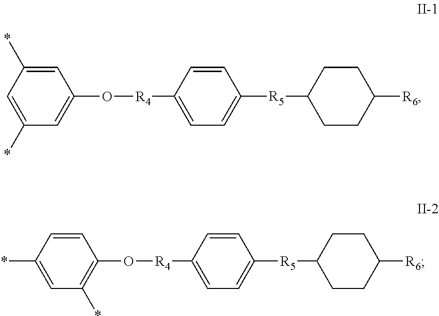
wherein definitions of R₄, R₅, and R₆ in the formula II-1 and the formula II-2 are the same as definitions of R₄, R₅, and R₆ in the formula II.

9. The liquid crystal alignment agent according to claim 7, wherein at least one of R₂ and R₃ is selected from a group consisting of:

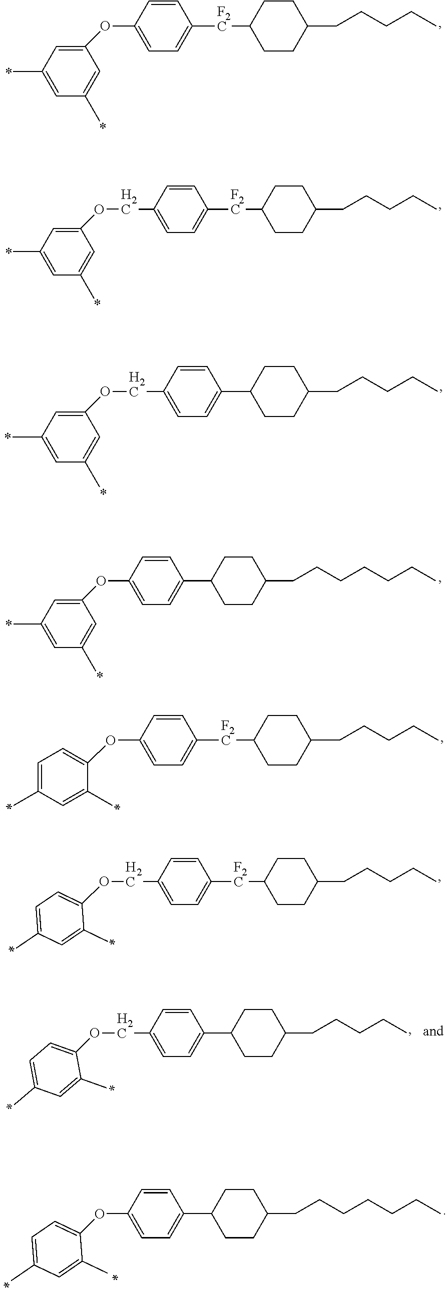

10. The liquid crystal alignment agent according to claim 7, wherein R₁ is selected from a group obtained after decarboxylation of an aliphatic tetracarboxylic dianhydride, a group obtained after decarboxylation of an alicyclic tetracarboxylic dianhydride, or a group obtained after decarboxylation of an aromatic tetracarboxylic dianhydride; and
wherein R₂ is represented by the formula II, and R₃ is different from R₂ and selected from a group obtained after deamination of an aliphatic diamine, a group obtained after deamination of an alicyclic diamine, or a group obtained after deamination of an aromatic diamine.

11. The liquid crystal alignment agent according to claim 7, comprising at least one of polyimide represented by formula I-1, polyimide represented by formula I-2, polyamic acid represented by formula III-1, or polyamic acid represented by formula III-2: 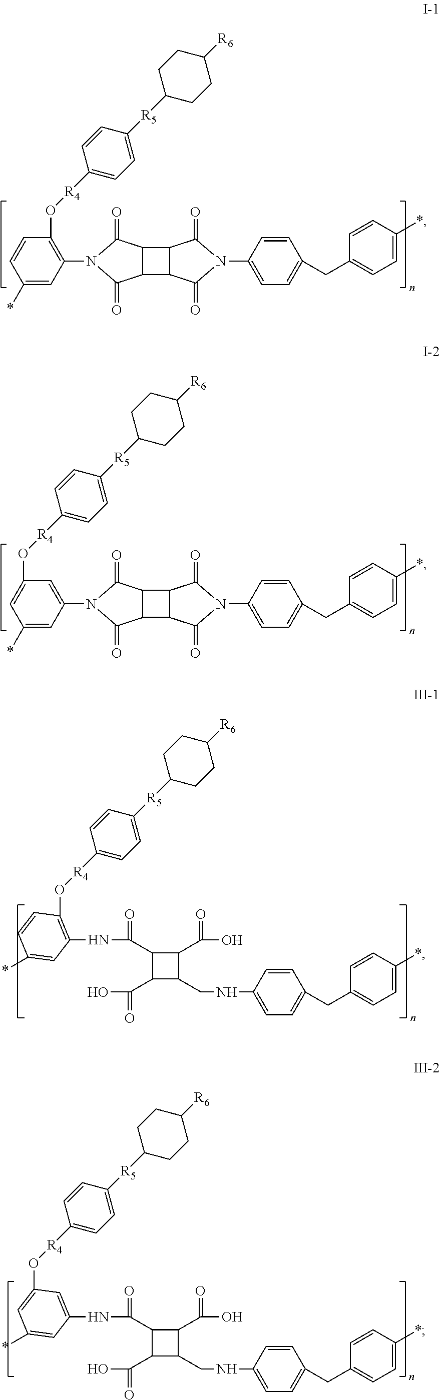
wherein definitions of R₄, R₅, and R₆ in the formulae I-1, I-2, III-1, and III-2 are the same as definitions of R₄, R₅, and R₆ in the formula II; and
n represents a positive integer.

12. The liquid crystal alignment agent according to claim 7, further comprising an organic solvent, wherein the organic solvent comprises at least one of N-methylpyrrolidone, N-ethylpyrrolidone, butyl carbonate, diethylene glycol monoethyl ether, or diacetone alcohol.

13. A method for manufacturing a display panel, comprising:
providing a first substrate and a second substrate;
providing the liquid crystal alignment agent according to claim 7;
applying the liquid crystal alignment agent on the first substrate and/or the second substrate to form a liquid crystal alignment film; and
forming a liquid crystal layer between the first substrate and the second substrate, wherein the liquid crystal alignment film is disposed close to the liquid crystal layer.

14. The method for manufacturing a display panel according to claim 13, wherein the liquid crystal alignment agent comprises the polyimide represented by the formula I, and a step of preparing the liquid crystal alignment agent comprises:
adding at least one tetracarboxylic dianhydride and at least one diamine to a first organic solvent system to obtain a polyamic acid solution by reaction;
forming a polyimide solution by dehydrative cyclization reaction of polyamic acid in the polyamic acid solution; and
extracting polyimide from the polyimide solution, and adding the polyimide to a second organic solvent system to obtain the liquid crystal alignment agent;
wherein the at least one diamine comprises a side-chain diamine represented by formula IV: 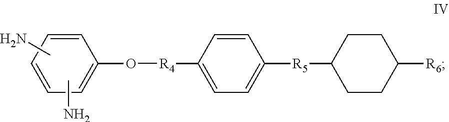
and
wherein definitions of R₄, R₅, and R₆ in the formula IV are the same as definitions of R₄, R₅, and R₆ in the formula II.

15. The method for manufacturing a display panel according to claim 14, wherein the side-chain diamine is at least one selected from diamines represented by formula IV-1 or formula IV-2: 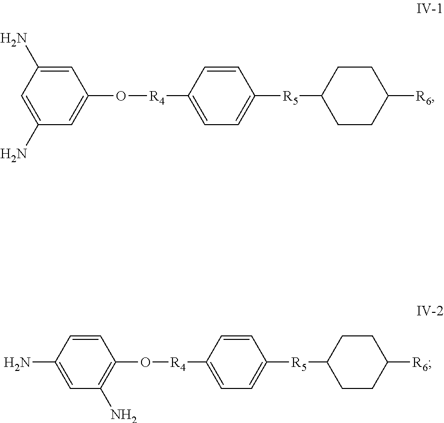
wherein definitions of R₄, R₅, and R₆ in the formula IV-1 and the formula IV-2 are the same as definitions of R₄, R₅, and R₆ in the formula II.

16. The method for manufacturing a display panel according to claim 14, wherein the side-chain diamine is at least one selected from a group consisting of compounds IV-1-1 to IV-2-4:

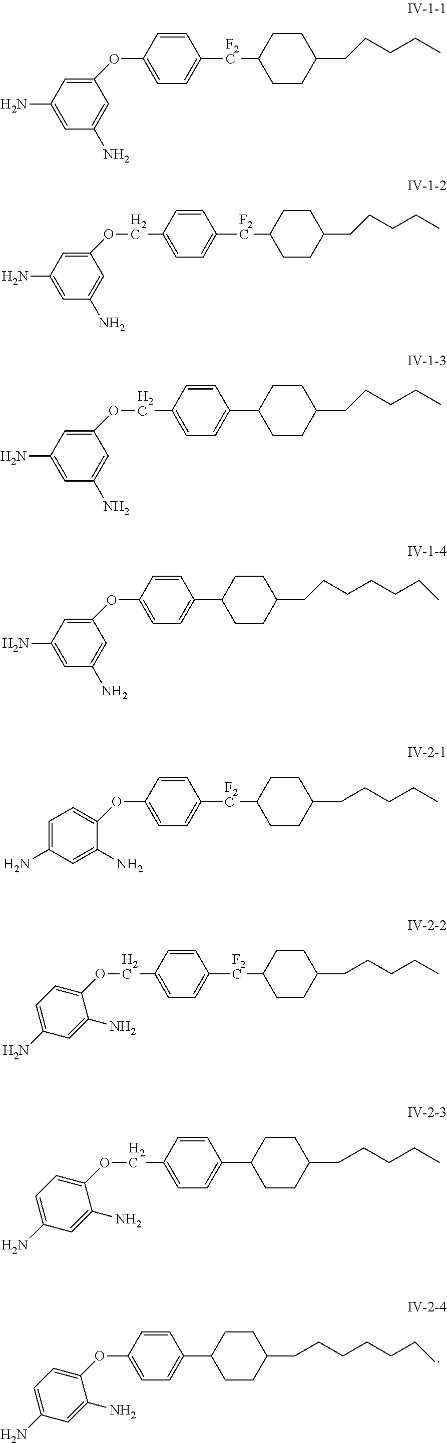

17. The method for manufacturing a display panel according to claim 14, wherein a molar percentage of the side-chain diamine in a solution composed of the at least one tetracarboxylic dianhydride and the at least one diamine is greater than or equal to 10% and less than or equal to 20%.

18. The method for manufacturing a display panel according to claim 17, wherein a molar percentage of the at least one tetracarboxylic dianhydride in the solution composed of the at least one tetracarboxylic dianhydride and the at least one diamine is equal to 50%.

19. The method for manufacturing the display panel according to claim 14, wherein the at least one tetracarboxylic dianhydride comprises cyclobutane-1,2,3,4-tetracarboxylic dianhydride, and the at least one diamine further comprises 4,4′-methylenedianiline.

20. The method for manufacturing a display panel according to claim 14, wherein the first organic solvent system comprises N-methylpyrrolidone, and the second organic solvent system comprises at least one of N-methylpyrrolidone, N-ethylpyrrolidone, butyl carbonate, diethylene glycol monoethyl ether, or diacetone alcohol.
